(19) United States
(12) Patent Application Publication
(10) Pub. No.: US 2015/0175020 A1
(43) Pub. Date: Jun. 25, 2015

(54) VEHICLE BATTERY CHARGING APPARATUS AND METHOD USING THE SAME

(71) Applicant: Hyundai Motor Company, Seoul (KR)

(72) Inventors: Jeeheon Kim, Guri (KR); Gyu Yeong Choe, Suwon (KR); Chang Dug Lee, Suwon (KR)

(21) Appl. No.: 14/460,752

(22) Filed: Aug. 15, 2014

(30) Foreign Application Priority Data
Dec. 23, 2013 (KR) 10-2013-0161722

(51) Int. Cl. B60L 11/18

(52) U.S. Cl. CPC B60L 11/1809

(57) ABSTRACT

A charging method for a vehicle is provided that includes receiving, by a controller, a control pilot (CP) signal from electric vehicle supply equipment (EVSE) and smoothing the CP signal using a duty ratio of the CP signal. In addition, the controller is configured to compensate the smoothed CP signal and determine whether the compensated CP signal is within a predetermined range. The vehicle battery is then charged when the compensated CP signal is within the predetermined range.

### CROSS-REFERENCE TO RELATED APPLICATION

This application claims priority to and the benefit of Korean Patent Application No. 10-2013-0161722 filed in the Korean Intellectual Property Office on Dec. 23, 2013, the entire contents of which are incorporated herein by reference.

### BACKGROUND

(a) Field of the Invention

The present invention relates to a vehicle charging apparatus and a charging method using the same, and more particularly, a vehicle charging apparatus and a charging method using the same that charge the vehicle battery more efficiently by decreasing noise of a control pilot signal in the charging apparatus for the vehicle.

(b) Description of the Related Art

Recently, global environmental contamination has become an increasing public concern, and thus use of clean energy is becoming more important. Particularly, air pollution in larger cities is increasing, and exhaust gas of a vehicle is one of main causes of the air pollution. Under such circumstances, research for commercializing electric vehicles, such as a hybrid vehicle, an electric vehicle, or a fuel cell vehicle that uses electricity (i.e. clean energy) as a power source, has recently been actively conducted.

An electric vehicle is supplied with electricity from an external source and then charges a battery with the supplied electricity, and utilizes a charged voltage in the battery to generate power as mechanical energy through a motor coupled to wheels. In other words, since the electric vehicle uses the charged voltage in the battery to drive the motor, a high capacity rechargeable battery is used in the electric vehicle and is provided with a battery charging apparatus for charging the high capacity rechargeable battery. Battery charging methods can be classified into a high-speed charging method through a separate charger and a low-speed charging method through a charger installed within the vehicle.

The high-speed charging method refers to charging of the battery for a substantially short period of time while the vehicle is temporarily parked, and the low-speed charging method refers to charging of the battery to a full charging state for a substantially long period time since the vehicle is being driven during charging. In the case of the low-speed charging method, an on-board charger (OBC) is coupled to a low-speed charging port and converts alternating current (AC) power into direct current (DC) power to charge the battery. The on-board charger is supplied with electricity through electric vehicle supply equipment

(EVSE), and the EVSE detects a voltage level of a control pilot (CP) signal to determine whether to begin charging when being supplied with electricity. However, when noise occurs in the control pilot signal and the voltage level varies due to the noise, charging may be insufficiently performed since the EVSE detects the voltage level while the noise is occurring.

The above information disclosed in this section is merely for enhancement of understanding of the background of the invention and therefore it may contain information that does not form the prior art that is already known in this country to a person of ordinary skill in the art.

### SUMMARY

The present invention provides a charging apparatus for a vehicle and a charging method using the same that may reduce errors and failures due to noise received from electric vehicle supply equipment (EVSE). Further, other technical objects desired to be achieved in the present invention are not limited to the aforementioned objects, and other technical objects not described above will be apparent to those skilled in the art from the disclosure of the present invention.

An exemplary embodiment of the present invention provides a charging method for a vehicle, that may include: receiving a control pilot (CP) signal from electric vehicle supply equipment (EVSE); smoothing the CP signal using a duty ratio of the CP signal; compensating the smoothed CP signal; determining whether the compensated CP signal is within a predetermined range; and charging the vehicle battery when the compensated CP signal is within the predetermined range.

The charging method may further include determining fault occurrence when the compensated CP signal exceeds the predetermined range. The compensating of the smoothed CP signal may include compensating the control signal by adding a reciprocal of the duty ratio of the CP signal to the smoothed CP signal.

An exemplary embodiment of the present invention provides an on-board charger, that may include: a smoothing unit configured to receive a control pilot (CP) signal from electric vehicle supply equipment (EVSE) and configured to smooth the CP signal using a duty ratio of the CP signal; a compensator configured to compensate the smoothed CP signal; and a charging controller configured to determine whether the compensated CP signal is within a predetermined range and configured to charge a vehicle battery when the compensated CP signal is within the predetermined range. The charging controller may be configured to determine fault occurrence when the compensated CP signal exceeds the predetermined range. The compensator may be configured to compensate the smoothed CP signal by adding a reciprocal of the duty ratio to the smoothed CP signal.

An exemplary embodiment of the present invention provides a charging apparatus for a vehicle battery, that may include: the vehicle battery; a battery management system (BMS) configured to detect a status of the vehicle battery; and an on-board charger configured to charge the vehicle battery by receiving a control pilot (CP) signal and charging power from electric vehicle supply equipment (EVSE), smoothing the CP signal using a duty ratio thereof, compensating the smoothed CP signal, determining whether the compensated CP signal is within a predetermined range, and charging the vehicle battery when the compensated CP signal is within the predetermined range. The on-board charger may also be configured to determine fault occurrence when the compensated CP signal exceeds the predetermined range. The on-board charger may be configured to compensate the smoothed CP signal by adding a reciprocal of the duty ratio to the smoothed CP signal. The on-board charger may be executed by a controller having a processor and a memory.

Effects of the charging apparatus for the vehicle battery according to the present invention are as follows. According to at least one of the exemplary embodiments of the present invention, it has an advantage of reducing misdiagnoses (e.g., failures or errors in charging) due to the noise of the control pilot signal. The above effects desired to be achieved in the present invention are not limited to the aforementioned effects, and other effects not described above will be apparent to those skilled in the art from the disclosure of the present invention.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is an exemplary diagram of a vehicle including a charging apparatus for a vehicle according to an exemplary embodiment of the present invention;

FIG. 2 is an exemplary diagram of the charging apparatus for the vehicle and external electric vehicle supply equipment (EVSE) according to the exemplary embodiment of the present invention; and

FIG. 3 is an exemplary flowchart illustrating a charging method according to the exemplary embodiment of the present invention with which the charging apparatus for the vehicle charges the vehicle.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the following detailed description, only certain exemplary embodiments of the present invention have been shown and described, simply by way of illustration. As those skilled in the art would realize, the described exemplary embodiments may be modified in various different ways, all without departing from the spirit or scope of the present invention. Throughout the specification, unless explicitly described to the contrary, the word “comprise” and variations such as “comprises” or “comprising” will be understood to imply the inclusion of stated elements but not the exclusion of any other elements.

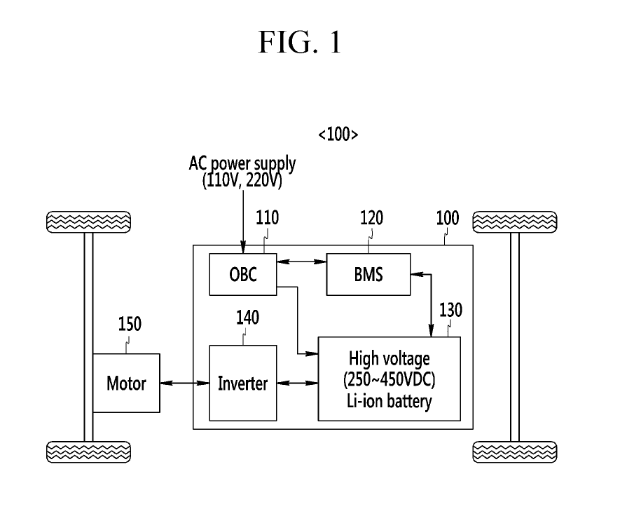

An exemplary embodiment of the present invention will now be described in detail with reference to the accompanying drawings. FIG. 1 is an exemplary diagram of a vehicle 10 including a charging apparatus for a vehicle 100 according to an exemplary embodiment of the present invention.

As illustrated, the vehicle 10 may be connected to an external AC power supply (e.g., about 110 V, 220 V, etc.) to receive charging power for a vehicle battery 130 installed within the vehicle. In particular, an on-board charger (OBC) 110 may be configured to receive a control pilot (CP) signal from electric vehicle supply equipment (EVSE) to supply the external AC power, and may be configured to charge the vehicle battery 130 with the supplied power that is the external AC power. The CP signal may be generated as a constant voltage signal at about 12 V or about 9 V or as a PWM signal at about +9 V/−12 V or about +6 V/−12 V, and hereinafter, may be assumed to be generated as the PWM signal.

Herein, the EVSE may be charging equipment located within a home, or a charging stand located a charging spot for the vehicle such as a gas station. Thus, in the present specification and the claims that follow, it is to be understood that the EVSE may include all of an in-cable control box (ICCB), a charging circuit interrupt device (CCID), etc.

The vehicle battery 130 may be installed within a hybrid vehicle or electric vehicle and may be configured to supply power to a driving motor 150. The vehicle battery 130 may be configured as a battery pack in which cells are connected in series as a single pack based on required capacity of the battery. Thus, in the present specification and the claims that follow, it is to be understood that the vehicle battery 130 may include all types of batteries including a battery pack applicable to a hybrid vehicle or electric vehicle.

Further, a battery management system 120 (BMS) may be configured to communicate with the OBC 110 and/or the vehicle battery 130 to receive/transmit control information, and may be configured to monitor a status of the vehicle battery 130. Specifically, the BMS 120 may be configured to measure or calculate an open circuit voltage (OCV), a temperature, and a state of charge (SOC) of the vehicle battery 130. Then, the motor 150 installed within the vehicle may be supplied with charged power of the vehicle battery 130, which may be converted through an inverter 140.

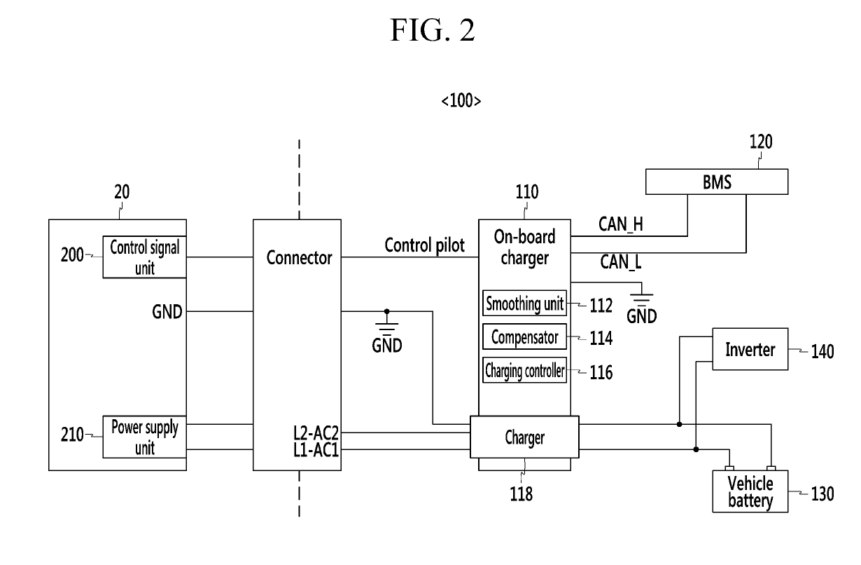

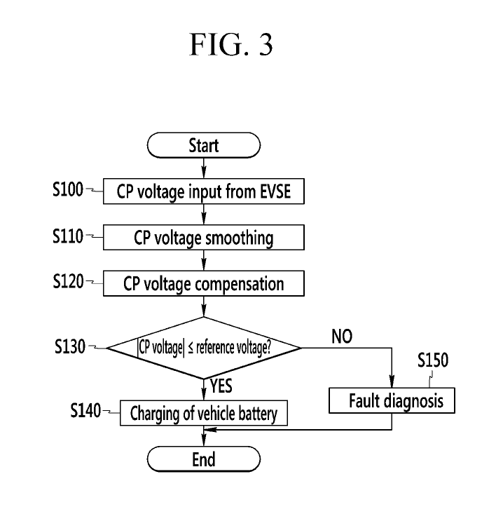

Referring to FIGS. 2 and 3, the charging apparatus for the vehicle 100 will now be described in which the OBC 110 for controlling charging of the vehicle may be configured to receive the CP signal from an external EVSE to supply external AC power to charge the vehicle battery 130. FIG. 2 is an exemplary diagram of the charging apparatus for the vehicle 100 and the external EVSE according to the exemplary embodiment of the present invention, and FIG. 3 is an exemplary flowchart illustrating a charging method according to the exemplary embodiment of the present invention with which the charging apparatus for the vehicle 100 charges the vehicle.

As shown in FIG. 2, the charging apparatus for the vehicle 100 and the external EVSE may be connected via a connector 300. The charging apparatus for the vehicle 100 may include the OBC 110, the BMS 120, and the vehicle battery 130. In addition, the external EVSE may include a control signal unit 200 and a power supply unit 210. Since constituent elements shown in FIG. 1 are not essential, the charging apparatus for the vehicle 100 and an external EVSE having more constituent elements or less constituent elements may be embodied. The constituent elements will now be sequentially described.

The OBC 110 may be executed by a controller and may include a smoothing unit 112, a compensator 114, a charging controller 116, and a charger 118. The OBC 110 may be configured to receive the CP signal from the external EVSE via the connector 300 (S100). In this case, the OBC 110 may be configured to receive power from the connector 300 to charge the vehicle. The smoothing unit 112 may be configured to receive the CP signal from the control signal unit 200 of the external EVSE via the connector 300 to smooth the CP signal (S110). In particular, the smoothing unit 112 may be configured to smooth the CP signal by a duty ratio of the CP signal.

Further, the CP signal may have noise ripples eliminated by the smoothing unit 112 to be output to the compensator 114. The compensator 114 may be configured to compensate the smoothed CP signal (S120). Since the CP signal may be decreased by the duty ratio while being smoothed by the smoothing unit 112, the compensator 114 accordingly may be configured to compensate the CP signal. The compensator 114 may be configured to add a reciprocal of the duty ratio to the smoothed CP signal to compensate the CP signal. The charging controller 116 may use the CP signal output from the compensator 114 to control or adjust the charging of the charger 118. Specifically, the charging controller 116 may be operated by the OBC 110 to determine whether the CP signal compensated by the compensator 114 is less than or equal to a reference voltage (S130).

When the CP signal is less than or equal to the reference voltage, the charging controller 116 may be configured to operate the charger and generate a signal to supply external charging power thereto (S140) to output the generated signal to the charger. Then, depending on the input signal, the charger may be configured to use external charging power to charge the vehicle battery 130. Meanwhile, when the CP signal exceeds the reference voltage, the charging controller 116 may be configured to determine a fault occurrence (e.g., a failure) of the external EVSE or connector 300 (S150).

While this invention has been described in connection with what is presently considered to be practical exemplary embodiments, it is to be understood that the invention is not limited to the disclosed exemplary embodiments. On the contrary, it is intended to cover various modifications and equivalent arrangements included within the spirit and scope of the appended claims.

### DESCRIPTION OF SYMBOLS

100: charging apparatus for vehicle

110: on-board charger

112: smoothing unit

114: compensator

116: charging controller

118: charger

120: BMS

130: vehicle battery

140: inverter

150: motor

200: control signal unit

210: power supply unit

What is claimed is:

1. A charging method for a vehicle, comprising:
receiving, by a controller, a control pilot (CP) signal from electric vehicle supply equipment (EVSE);
smoothing, by the controller, the CP signal using a duty ratio of the CP signal;
compensating, by the controller, the smoothed CP signal;
determining, by the controller, whether the compensated CP signal is within a predetermined range; and
charging, by the controller, the vehicle battery when the compensated CP signal is within the predetermined range.

2. The method of claim 1, further comprising:
determining, by the controller, a fault occurrence when the compensated CP signal exceeds the predetermined range.

3. The method of claim 1, wherein the compensating of the smoothed CP signal includes compensating, by the controller, the control signal by adding a reciprocal of the duty ratio of the CP signal to the smoothed CP signal.

4. An on-board charger, comprising:
a memory configured to store program instructions; and
a processor configured to execute the program instructions, the program instructions when executed configured to:
receive a control pilot (CP) signal from electric vehicle supply equipment (EVSE);
smooth the CP signal using a duty ratio of the CP signal;
compensate the smoothed CP signal;
determine whether the compensated CP signal is within a predetermined range; and
charge a vehicle battery when the compensated CP signal is within the predetermined range.

5. The on-board charger of claim 4, wherein the program instructions when executed are further configured to determine a fault occurrence when the compensated CP signal exceeds the predetermined range.

6. The on-board charger of claim 5, wherein the program instructions when executed are further configured to compensate the smoothed CP signal by adding a reciprocal of the duty ratio to the smoothed CP signal.

7. A charging apparatus for a vehicle, comprising:
a vehicle battery;
a battery management system (BMS) configured to detect a status of the vehicle battery; and
an on-board charger configured to charge the vehicle battery by receiving a control pilot (CP) signal and charging power from electric vehicle supply equipment (EVSE), smoothing the CP signal using a duty ratio thereof, compensating the smoothed CP signal, determining whether the compensated CP signal is within a predetermined range, and charging the vehicle battery when the compensated CP signal is within the predetermined range.

8. The apparatus of claim 7, wherein the on-board charger is configured to determine a fault occurrence when the compensated CP signal exceeds the predetermined range.

9. The apparatus of claim 7, wherein the on-board charger is configured to compensate the smoothed CP signal by adding a reciprocal of the duty ratio to the smoothed CP signal.

10. A non-transitory computer readable medium containing program instructions executed by a controller, the computer readable medium comprising:
program instructions that receive a control pilot (CP) signal from electric vehicle supply equipment (EVSE);
program instructions that smooth the CP signal using a duty ratio of the CP signal;
program instructions that compensate the smoothed CP signal;
program instructions that determine whether the compensated CP signal is within a predetermined range; and
program instructions that charge a vehicle battery when the compensated CP signal is within the predetermined range.

11. The non-transitory computer readable medium of claim 10, further comprising program instructions that determine a fault occurrence when the compensated CP signal exceeds the predetermined range.

12. The non-transitory computer readable medium of claim 10, further comprising program instructions that compensate the smoothed CP signal by adding a reciprocal of the duty ratio to the smoothed CP signal.
